(19) United States
(12) Patent Application Publication
(10) Pub. No.: US 2009/0055240 A1
(43) Pub. Date: Feb. 26, 2009

(54) SYSTEM AND METHOD FOR MANAGING CONFERENCE PRESENTERS

(76) Inventor: GIDEON I. GARTNER, New York, NY (US)

Correspondence Address: HOLLAND & KNIGHT LLP, 10 ST. JAMES AVENUE, 11th Floor, BOSTON, MA, 02116-3889, US

(21) Appl. No.: 12/193,454

(22) Filed: Aug. 18, 2008

Related U.S. Application Data
(60) Provisional application No. 60/956,427, filed on Aug. 17, 2007.
(60) Provisional application No. 60/956,429, filed on Aug. 17, 2007.
(60) Provisional application No. 60/956,432, filed on Aug. 17, 2007.
(60) Provisional application No. 60/956,433, filed on Aug. 17, 2007.
(60) Provisional application No. 60/956,546, filed on Aug. 17, 2007.
(60) Provisional application No. 60/956,552, filed on Aug. 17, 2007.
(60) Provisional application No. 60/956,556, filed on Aug. 17, 2007.

(51) Int. Cl. G06Q 10/00

(52) U.S. Cl. 705/8

(57) ABSTRACT

A method includes defining a plurality of attendee groups. Each attendee group includes a plurality of attendee slots and a presenter slot. A first presenter is assigned to a presenter slot of a first attendee group during a first conference portion. A second presenter is assigned to the presenter slot of the first attendee group during a second conference portion.

### RELATED APPLICATION(S)

This application claims the benefit of U.S. Provisional Patent Application Ser. No. 60/956,427, entitled SPIDER, filed 17 Aug. 2007, the contents of which are herein incorporated by reference.

This application claims the benefit of U.S. Provisional Patent Application Ser. No. 60/956,429, entitled KNOWLEDGE EXCHANGE PROCESS, filed 17 Aug. 2007, the contents of which are herein incorporated by reference.

This application claims the benefit of U.S. Provisional Patent Application Ser. No. 60/956,432, entitled PROCESS FOR EXPOSING CONFERENCE ATTENDEES TO PRESENTERS, filed 17 Aug. 2007, the contents of which are herein incorporated by reference.

This application claims the benefit of U.S. Provisional Patent Application Ser. No. 60/956,433, entitled SYSTEM FOR ORGANIZING CHARACTERISTICS OF VARIOUS CURRENT IT PRODUCTS, AND FORECASTING SUCCESSOR PRODUCTS, filed 17 Aug. 2007, the contents of which are herein incorporated by reference.

This application claims the benefit of U.S. Provisional Patent Application Ser. No. 60/956,546, entitled CLIENT/EXPERT SWITCH, filed 17 Aug. 2007, the contents of which are herein incorporated by reference.

This application claims the benefit of U.S. Provisional Patent Application Ser. No. 60/956,552, entitled OBJECTIVITY CONTENT FARM/WISDOM CENTER, filed 17 Aug. 2007, the contents of which are herein incorporated by reference.

This application claims the benefit of U.S. Provisional Patent Application Ser. No. 60/956,556, entitled TRIANGULATION, filed 17 Aug. 2007, the contents of which are herein incorporated by reference.

### TECHNICAL FIELD

This disclosure relates to methodologies for organizing conferences and. more particularly, to methodologies for organizing conferences that include presenters.

### BACKGROUND

People often attend conferences to listen to various presenters speak. Additionally, attendees of conferences are often given the opportunity to mingle and chat with the various presenters. Accordingly, during a networking portion of the conference, the presenters may be approached by the attendees and engaged in conversation. Unfortunately and as is often the case, the first person to chat with an “in demand” presenter may never disengage the presenter. Therefore, the presenters may mingle and chat with a comparatively few number of conference attendees.

### SUMMARY OF DISCLOSURE

In a first implementation, a method includes defining a plurality of attendee groups. Each attendee group includes a plurality of attendee slots and a presenter slot. A first presenter is assigned to a presenter slot of a first attendee group during a first conference portion. A second presenter is assigned to the presenter slot of the first attendee group during a second conference portion.

One or more of the following features may be included. The first presenter may be assigned to a presenter slot of an attendee group other than the first attendee group during a conference portion other than the first conference portion. The second presenter may be assigned to a presenter slot of an attendee group other than the first attendee group during a conference portion other than the second conference portion. A third presenter may be assigned to the presenter slot of the first attendee group during a third conference portion. The third presenter may be assigned to a presenter slot of an attendee group other than the first attendee group during a conference portion other than the third conference portion.

Each of the plurality of attendee groups may define a conference table. The total number of presenters may be equal to the total number of attendee groups. The total number of presenters may be less than the total number of conference portions. The total number of presenters may be equal to the total number of conference portions.

In another implementation, a method includes defining a plurality of conference tables. Each conference table includes a plurality of attendee slots and a presenter slot. A first presenter is assigned to a presenter slot of a first conference table during a first conference portion. A second presenter is assigned to the presenter slot of the first conference table during a second conference portion.

One or more of the following features may be included. The first presenter may be assigned to a presenter slot of a conference table other than the first conference table during a conference portion other than the first conference portion. The second presenter may be assigned to a presenter slot of a conference table other than the first conference table during a conference portion other than the second conference portion. A third presenter may be assigned to the presenter slot of the first conference table during a third conference portion. The third presenter may be assigned to a presenter slot of a conference table other than the first conference table during a conference portion other than the third conference portion.

The total number of presenters may be equal to the total number of conference tables. The total number of presenters may be less than the total number of conference portions. The total number of presenters may be equal to the total number of conference portions.

In another implementation, a method includes defining a plurality of conference tables. Each conference table includes a plurality of attendee slots and a presenter slot. A first presenter is assigned to a presenter slot of a first conference table during a first conference portion. A second presenter is assigned to the presenter slot of the first conference table during a second conference portion. A third presenter is assigned to the presenter slot of the first conference table during a third conference portion.

One or more of the following features may be included. The first presenter may be assigned to a presenter slot of a conference table other than the first conference table during a conference portion other than the first conference portion. The second presenter may be assigned to a presenter slot of a conference table other than the first conference table during a conference portion other than the second conference portion. The third presenter may be assigned to a presenter slot of a conference table other than the first conference table during a conference portion other than the third conference portion. The total number of presenters may be equal to the total number of conference tables. The total number of presenters may be less than or equal to the total number of conference portions.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a flowchart of a presenter management methodology; and.

FIG. 2 is a diagrammatic view of a conference facility.

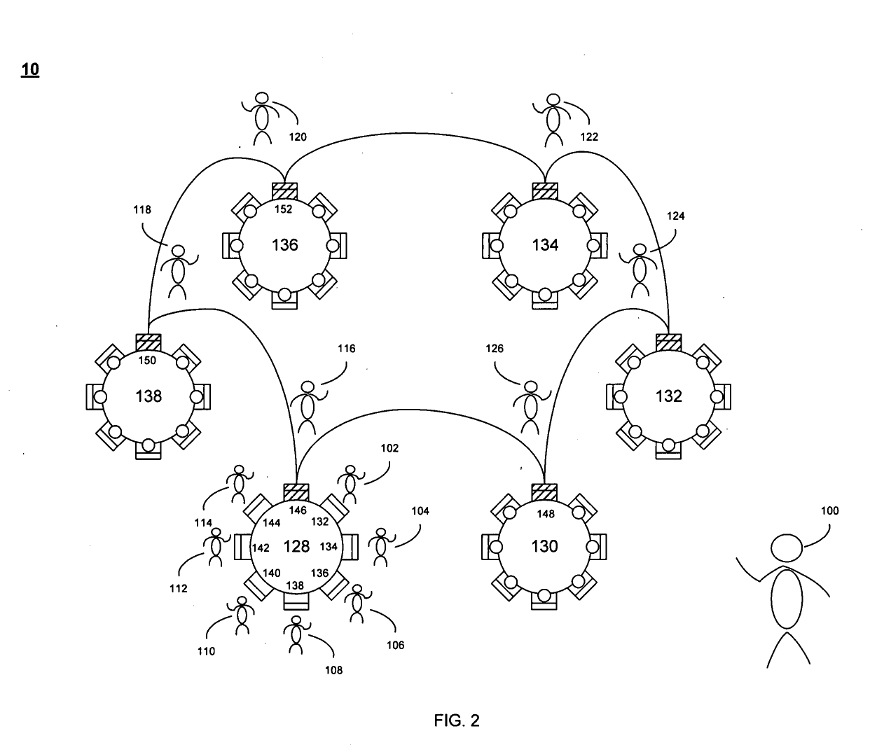

Like reference symbols in the various drawings indicate like elements.

### DETAILED DESCRIPTION OF THE PREFERRED EMBODIMENTS

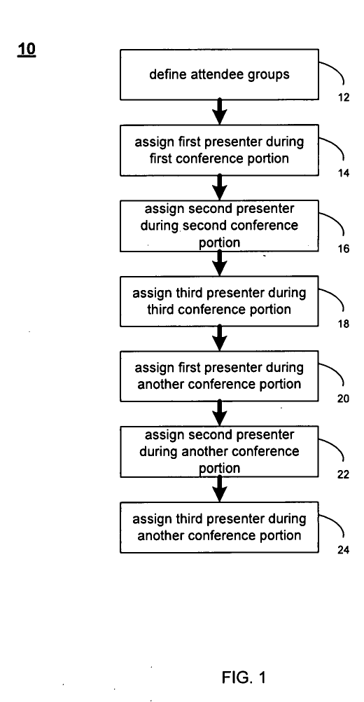

Referring to FIGS. 1 & 2, there is shown one embodiment of presenter management methodology 10. Assume for illustrative purposes that conference organizer 100 is organizing a conference concerning a specific topic of interest to the attendees of the conference (e.g., conference attendees 102, 104, 106, 108, 110, 112, 114). Examples of such conferences may include but are not limited to those conferences concerning information technology (IT) issues.

Assume for illustrative purposes that conference organizer 100 arranges to have various presenters (e.g., presenters 116, 118, 120, 122, 124, 126) give presentations/lectures concerning various topics during the conference. Examples of the topics that presenters 116, 118, 120, 122, 124, 126 may present/lecture about may include but are not limited to IT related topics. Presenters 116, 118, 120, 122, 124, 126 may be considered experts in the field of the specific topic of the conference (e.g., IT issues).

The conference organized by conference organizer 100 may be a dinner conference in which conference attendees 102, 104, 106, 108, 110, 112, 114 sit down for formal dining (e.g., a multi-course meal) during the conference. Alternatively, the conference may be a “cocktail-party” conference in which conference attendees 102, 104, 106, 108, 110, 112, 114 sit down for informal dining (e.g., hors d'œuvre and cocktails) during the conference. Additionally, the dining portion of the conference may be preceded or followed by a panel discussion in which at least a portion of presenters 116, 118, 120, 122, 124, 126 provide their presentation/lecture to the conference attendees (e.g., conference attendees 102, 104, 106, 108, 110, 112, 114).

In order to effectuate a more personal level of engagement between e.g., presenters 116, 118, 120, 122, 124, 126 and conference attendees 102, 104, 106, 108, 110, 112, 114, presenter management methodology 10 may be utilized.

Specifically, presenter management methodology 10 may allow conference organizer 100 to define 12 a plurality of attendee groups 128, 130, 132, 134, 136, 138. Examples of such attendee groups may include but are not limited to conference tables for use by the various attendees of the conference.

For illustrative purposes, attendee groups 128, 130, 132, 134, 136, 138 shall be described as conference tables. However, this is for illustrative purposes only and is not intended to be a limitation of this disclosure, as other configurations are possible and are considered to be within the scope of this disclosure. For example, attendee groups 128, 130, 132, 134, 136, 138 may be individual rooms/sections within the conference in which various conference attendees (e.g., conference attendees 102, 104, 106, 108, 110, 112, 114) are situated during the conference.

Assuming for illustrative purposes that attendee groups 128, 130, 132, 134, 136, 138 are conference tables (e.g., conference tables 128, 130, 132, 134, 136, 138), each conference may include a plurality of attendee slots and a presenter slot. Accordingly, assume that each conference table includes eight seating slots (e.g., chairs). Further, assume that seven of the eight seating slots are defined as attendee slots 132, 134, 136, 138, 140, 142, 144 (e.g., for use by conference attendees). Further, assume that one of the eight seating slots is defined as presenter slot 146 (e.g., for use by a presenter).

When organizing the conference, presenter management methodology 10 may allow conference organizer 100 to assign 14 a first presenter (e.g., presenter 116) to presenter slot 146 of conference table 128 during a first conference portion (to be explained below in greater detail). Further, presenter management methodology 10 may allow conference organizer 100 to assign 16 a second presenter (e.g., presenter 118) to presenter slot 146 of conference table 128 during a second conference portion (to be explained below in greater detail). Further still, presenter management methodology 10 may allow conference organizer 100 to assign 18 a third presenter (e.g., presenter 120) to presenter slot 146 of conference table 128 during a third conference portion (to be explained below in greater detail). Additionally, conference attendees (e.g., conference attendees 102, 104, 106, 108, 110, 112, 114) may be assigned to attendee slots 132, 134, 136, 138, 140, 142, 144 (respectively) for the entirety of the conference being organized by conference organizer 100).

As discussed above, the various presenters (e.g., presenters 116, 118, 120) may be assigned to presenter slot 146 of conference table 128 during various portions of conference. For example, assume for illustrative purposes that the conference being organized by conference organizer 100 is a three-hour conference. Conference organizer 100 may decide to divide this three-hour conference into six thirty-minute conference portions. Accordingly, conference organizer 100 may assign 14 presenter 116 to presenter slot 146 of conference table 128 during the first thirty minute conference portion. Conference organizer 100 may assign 16 presenter 118 to presenter slot 146 of conference table 128 during the second thirty minute conference portion. And conference organizer 100 may assign 18 presenter 120 to presenter slot 146 of conference table 128 during the third thirty minute conference portion.

Accordingly, through the use of presenter management methodology 10, the various presenters of the conference may migrate through the various conference tables of the conference, thus allowing the various attendees of the conference to meet and interact with a plurality of the presenters of the conference.

Continuing with the above-stated example in which the three-hour conference was divided into six thirty-minute portions, presenter management methodology 10 may allow conference organizer 100 to assign 20 the first presenter (i.e., presenter 116) to a presenter slot at a conference table other than conference table 128 during a conference portion other than the first thirty-minute conference portion. For example, conference organizer 100 may assign presenter 116 to presenter slot 148 of conference table 130 during the second thirty-minute portion of the conference being organized by conference organizer 100.

Further, presenter management methodology 10 may allow conference organizer 100 to assign 22 the second presenter (i.e., presenter 118) to a presenter slot at a conference table other than conference table 128 during a conference portion other than the second thirty-minute conference portion. For example, conference organizer 100 may assign presenter 118 to presenter slot 150 of conference table 138 during the first thirty-minute portion of the conference being organized by conference organizer 100.

Additionally, presenter management methodology 10 may allow conference organizer 100 to assign 24 the third presenter (i.e., presenter 120) to a presenter slot at a conference table other than conference table 128 during a conference portion other than the third thirty-minute conference portion. For example, conference organizer 100 may assign presenter 120 to presenter slot 152 of conference table 136 during the first thirty-minute portion of the conference being organized by conference organizer 100.

When dividing the conference into various smaller portions, the manner in which the conference is divided may vary depending on the particular preferences of conference organizer 100, as will be discussed below in the following non-limiting examples, which are presented for illustrative purposes only and are not intended to be a limitation of the scope of this disclosure. For example, the total number of presenters (e.g., presenters 116, 118, 120, 122, 124, 126) may be equal to the total number of conference tables (e.g., conference tables 128, 130, 132, 134, 136, 138). Further, the total number of presenters (e.g., presenters 116, 118, 120, 122, 124, 126) may be less than or equal to the total number of conference portions (e.g., six thirty-minute conference portions).

Accordingly, continuing with the above-stated example in which there are six conference tables (e.g., conference tables 128, 130, 132, 134, 136, 138), six presenters (e.g., presenters 116, 118, 120, 122, 124, 126), and six thirty-minute conference portions, the following table provides one illustrative example of the location of the various presenters during the various conference portions.

| | table 128 | table 130 | table 132 | table 134 | table 136 | table 138 |
|---|---|---|---|---|---|---|
| first | presenter | presenter | presenter | presenter | presenter | presenter |
| portion | 116 | 126 | 124 | 122 | 120 | 118 |
| second | presenter | presenter | presenter | presenter | presenter | presenter |
| portion | 118 | 116 | 126 | 124 | 122 | 120 |
| third | presenter | presenter | presenter | presenter | presenter | presenter |
| portion | 120 | 118 | 116 | 126 | 124 | 122 |
| fourth | presenter | presenter | presenter | presenter | presenter | presenter |
| portion | 122 | 120 | 118 | 116 | 126 | 124 |
| fifth | presenter | presenter | presenter | presenter | presenter | presenter |
| portion | 124 | 122 | 120 | 118 | 116 | 126 |
| sixth | presenter | presenter | presenter | presenter | presenter | presenter |
| portion | 126 | 124 | 122 | 120 | 118 | 116 |

As illustrated in the above table and in this particular example, during the course of the three-hour conference, each of the six presenters (e.g., presenters 116, 118, 120, 122, 124, 126) will spend one thirty-minute portion at each of the six conference tables. Accordingly, all attendees of the conference organized by conference organizer 100 will have the opportunity to chat with each of the six presenters for thirty minutes in a more intimate manner than that typically available to conference attendees.

While the conference organized by conference organizer 100 is described above as being divided into a number of portions that is equal to the number of presenters, this is for illustrative purposes only and is not intended to be a limitation of this disclosure, as other configurations are possible and are considered to be within the scope of this disclosure. For example, the conference may be divided into three sixty-minute portions. Accordingly and in such a configuration, all attendees of the conference organized by conference organizer 100 will have the opportunity to chat with three of the six presenters for sixty minutes in a more intimate manner than that typically available to conference attendees

While the conference organized by conference organizer 100 is described above as an IT related conference, this is for illustrative purposes only and is not intended to be a limitation of this disclosure, as other configurations are possible and are considered to be within the scope of this disclosure. For example, the conference organized by conference organizer 100 may be a biotechnology ethics conference, a self-motivation conference, or a sales conference.

A number of implementations have been described. Nevertheless, it will be understood that various modifications may be made. Accordingly, other implementations are within the scope of the following claims.

What is claimed is:

1. A method comprising:
defining a plurality of attendee groups, wherein each attendee group includes a plurality of attendee slots and a presenter slot;
assigning a first presenter to a presenter slot of a first attendee group during a first conference portion; and
assigning a second presenter to the presenter slot of the first attendee group during a second conference portion.

2. The method of claim 1 further comprising:
assigning the first presenter to a presenter slot of an attendee group other than the first attendee group during a conference portion other than the first conference portion.

3. The method of claim 1 further comprising:
assigning the second presenter to a presenter slot of an attendee group other than the first attendee group during a conference portion other than the second conference portion.

4. The method of claim 1 comprising:
assigning a third presenter to the presenter slot of the first attendee group during a third conference portion.

5. The method of claim 4 further comprising:
assigning the third presenter to a presenter slot of an attendee group other than the first attendee group during a conference portion other than the third conference portion.

6. The method of claim 4 wherein each of the plurality of attendee groups defines a conference table.

7. The method of claim 1 wherein the total number of presenters is equal to the total number of attendee groups.

8. The method of claim 1 wherein the total number of presenters is less than the total number of conference portions.

9. The method of claim 1 wherein the total number of presenters is equal to the total number of conference portions.

10. A method comprising:
defining a plurality of conference tables, wherein each conference table includes a plurality of attendee slots and a presenter slot;
assigning a first presenter to a presenter slot of a first conference table during a first conference portion; and
assigning a second presenter to the presenter slot of the first conference table during a second conference portion.

11. The method of claim 10 further comprising:
assigning the first presenter to a presenter slot of a conference table other than the first conference table during a conference portion other than the first conference portion.

12. The method of claim 10 further comprising:
assigning the second presenter to a presenter slot of a conference table other than the first conference table during a conference portion other than the second conference portion.

13. The method of claim 10 comprising:
assigning a third presenter to the presenter slot of the first conference table during a third conference portion.

14. The method of claim 13 further comprising:
assigning the third presenter to a presenter slot of a conference table other than the first conference table during a conference portion other than the third conference portion.

15. The method of claim 10 wherein the total number of presenters is equal to the total number of conference tables.

16. The method of claim 10 wherein the total number of presenters is less than the total number of conference portions.

17. The method of claim 10 wherein the total number of presenters is equal to the total number of conference portions.

18. A method comprising:
defining a plurality of conference tables, wherein each conference table includes a plurality of attendee slots and a presenter slot;
assigning a first presenter to a presenter slot of a first conference table during a first conference portion;
assigning a second presenter to the presenter slot of the first conference table during a second conference portion; and
assigning a third presenter to the presenter slot of the first conference table during a third conference portion.

19. The method of claim 18 further comprising:
assigning the first presenter to a presenter slot of a conference table other than the first conference table during a conference portion other than the first conference portion;
assigning the second presenter to a presenter slot of a conference table other than the first conference table during a conference portion other than the second conference portion; and
assigning the third presenter to a presenter slot of a conference table other than the first conference table during a conference portion other than the third conference portion.

20. The method of claim 18 wherein:
the total number of presenters is equal to the total number of conference tables; and
the total number of presenters is less than or equal to the total number of conference portions.
